(19) United States
(12) Patent Application Publication
(10) Pub. No.: US 2015/0191629 A1
(43) Pub. Date: Jul. 9, 2015

(54) SURFACE MODIFIER AND ARTICLE

(71) Applicant: Shin-Etsu Chemical Co., Ltd., Chiyoda-ku (JP)

(72) Inventors: Takashi MATSUDA, Annaka-shi (JP); Ryusuke SAKOH, Annaka-shi (JP); Yuji YAMANE, Annaka-shi (JP); Noriyuki KOIKE, Annaka-shi (JP)

(73) Assignee: Shin-Etsu Chemical Co., Ltd., Chiyoda-ku (JP)

(21) Appl. No.: 14/568,719

(22) Filed: Dec. 12, 2014

(30) Foreign Application Priority Data
Jan. 8, 2014 (JP) 2014-001578

(51) Int. Cl. C09D 183/08

(52) U.S. Cl. CPC C09D 183/08

(57) ABSTRACT

A surface modifier comprising an organosilicon-containing fluoropolymer having formula (1), partial hydrolyzate or hydrolytic condensate thereof is provided. In formula (1), Rf is perfluoroalkyl, OA is OCF₂CF₂CF₂CF₂, OCF₂CF₂CF₂, OCF(CF₃)CF₂, OCF₂CF₂ or OCF₂, X is F or CF₃, p=1-200, q=0, 1 or 2, r=1-5, h=0-4, k=2-16, m=2 or 3, R¹ is H or a hydrocarbon group, R² and R³ are hydrocarbon groups, and Z is a hydrolyzable group. The surface modifier is coated on a substrate to form a coating having water/oil repellency, quick water slip, UV resistance, heat resistance, and chemical resistance.

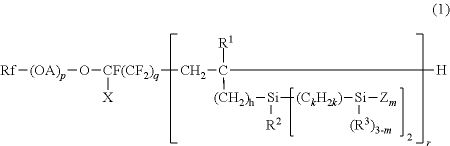

### CROSS-REFERENCE TO RELATED APPLICATION

This non-provisional application claims priority under 35 U.S.C. §119(a) on Patent Application No. 2014-001578 filed in Japan on Jan. 8, 2014, the entire contents of which are hereby incorporated by reference.

### TECHNICAL FIELD

This invention relates to a surface modifier with which various substrates are treated to form a layer that imparts antifouling, low friction (lubricity) and other functions thereto, and an article treated therewith.

### BACKGROUND ART

In the prior art, fluoropolymers having a hydrolyzable silyl group and methods for surface coating various substrates with the polymers to impart water repellent and antifouling properties thereto are known from many patent documents as will be cited below. On outdoor use of articles with these coatings, ultraviolet (UV) resistance is required. Also when the substrate is glass, there is a chance of contact with chemicals such as alkalis or heat treatment during the manufacture process. From these aspects, the fluoropolymers are desired to have improved chemical resistance and heat resistance.

Patent Document 1 discloses an iodine-containing linker between a fluoropolymer chain and a hydrolyzable silyl group. In long-term service, the polymer may be discolored due to liberation of iodine. A structural change resulting from such liberation may lead to poor UV resistance and heat resistance.

Patent Document 2 describes a compound containing a divalent organic group X in a linker between a fluoropolymer chain and a hydrolyzable silyl group. However, there is no explicit statement that X contains Si element. There are only Examples where X is O (oxygen atom). When X is O, which forms an ether bond, the molecule will have more rotational degrees of freedom. An improvement in lubricity is expected therefrom, but UV resistance, heat resistance, and chemical resistance are adversely affected.

Also Patent Document 3 discloses a compound comprising a fluoropolymer and a hydrolyzable silyl group wherein the linker therebetween contains an ether bond. The compound is poor in UV resistance, heat resistance, and chemical resistance.

Patent Document 4 discloses a compound containing a silicone (siloxane) spacer in a linker between a fluoropolymer and a hydrolyzable silyl group. Generally siloxane bonds have excellent UV resistance and heat resistance, but they are less durable to chemicals such as acids and alkalis. Likewise, Patent Document 5 describes that the linker between a fluoropolymer and a hydrolyzable silyl group contains a siloxane bond.

Also in Patent Document 6, a divalent organic group Q is described as the linker between a fluoropolymer and a hydrolyzable silyl group, but the inclusion of Si element is referred to nowhere. Since the compound has a siloxane structure or an ether bond, it is poor in UV resistance, heat resistance, and chemical resistance.

Patent Document 7 discloses a short chain alkylene group as the linker between a fluoropolymer and a hydrolyzable silyl group. Although the compound thus has a simple structure and is structurally durable, its coating on a glass substrate surface has insufficient alkali resistance. In this regard, a further improvement is needed.

### CITATION LIST

Patent Document 1: JP-A H01-294709 (U.S. Pat. No. 5,081,192)

Patent Document 2: JP-A 2008-534696 (U.S. Pat. No. 8,211,544)

Patent Document 3: JP-A 2000-308846

Patent Document 4: JP-A 2008-537557

Patent Document 5: JP-A 2012-157856 (US 20130303689)

Patent Document 6: JP-A 2012-072272 (US 20120077041)

Patent Document 7: JP-A H09-202648

### DISCLOSURE OF INVENTION

An object of the present invention is to provide a surface modifier which forms a coating having water/oil repellency and quick water slip as well as UV resistance, heat resistance, and chemical (alkali) resistance, and an article treated with the surface modifier.

The inventors have found that an organosilicon-containing fluoropolymer compound having a silalkylene structure in a linker between a fluoropolymer and a hydrolyzable silyl group, as represented by the general formula (1) below, a partial hydrolyzate thereof or a partial hydrolytic condensate thereof is useful as a surface modifier having water/oil repellency and quick water slip as well as UV resistance, heat resistance, and chemical resistance.

In one aspect, the invention provides a surface modifier comprising at least one compound selected from the group consisting of an organosilicon-containing fluoropolymer compound having the general formula (1), a partial hydrolyzate thereof, and a partial hydrolytic condensate thereof.

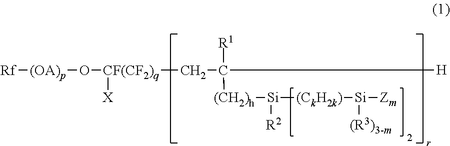

Herein Rf is a straight or branched perfluoroalkyl of 1 to 10 carbon atoms, OA is at least one group selected from the group consisting of OCF₂CF₂CF₂CF₂, OCF₂CF₂CF₂, OCF(CF₃)CF₂, OCF₂CF₂, and OCF₂, an arrangement order of OA may be random or block, X is F or CF₃, p is an integer of 1 to 200, q is 0, 1 or 2, r is an integer of 1 to 5, h is an integer of 0 to 4, k is an integer of 2 to 16, m is 2 or 3, R¹ is hydrogen or a monovalent hydrocarbon group of 1 to 10 carbon atoms, R² and R³ are each independently a monovalent hydrocarbon group of 1 to 10 carbon atoms, and Z is a hydrolyzable group.

In formula (1), preferably h is 0 or 1, k is 2 or 3, and m is 3, and more preferably, r is 1 or 2.

Preferably, the organosilicon-containing fluoropolymer compound of formula (1) has a number average molecular weight of 500 to 40,000.

In another aspect, the invention provides an article treated with the surface modifier defined above. The article is typically an optical article, touch panel, antireflective film, SiO₂-treated glass, strengthened glass, or quartz substrate.

### ADVANTAGEOUS EFFECTS OF INVENTION

Since the surface modifier of the invention comprises an organosilicon-containing fluoropolymer compound having a silalkylene structure as the linker between a fluoropolymer and a hydrolyzable silyl group and terminated with at least 4 hydrolyzable groups, a partial hydrolyzate thereof or a partial hydrolytic condensate thereof, it forms a coating layer which is tightly adherent to the substrate and has water/oil repellency and quick water slip as well as UV resistance, heat resistance, and chemical resistance.

### DESCRIPTION OF EMBODIMENTS

The surface modifier of the invention comprises an organosilicon-containing fluoropolymer compound (or fluorinated organosilane compound) having the general formula (1), a partial hydrolyzate thereof, and/or a partial hydrolytic condensate thereof.

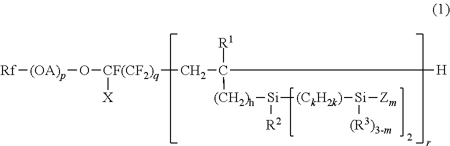

In formula (1), Rf is a straight or branched perfluoroalkyl group of 1 to 10 carbon atoms, preferably 1 to 6 carbon atoms. Examples include trifluoromethyl, pentafluoroethyl, heptafluoropropyl, 1-(trifluoromethyl)-1,2,2,2-tetrafluoroethyl, nonafluorobutyl, 1,1-di(trifluoromethyl)-2,2,2-trifluoroethyl, undecafluoropentyl, tridecafluorohexyl, pentadecafluoroheptyl, and heptadecafluorooctyl. Of these, trifluoromethyl, pentafluoroethyl, heptafluoropropyl, nonafluorobutyl, undecafluoropentyl, and tridecafluorohexyl are preferred, with trifluoromethyl, pentafluoroethyl, and heptafluoropropyl being more preferred.

OA is one or more groups selected from among OCF₂CF₂CF₂CF₂, OCF₂CF₂CF₂, OCF(CF₃)CF₂, OCF₂CF₂, and OCF₂. Where groups of two or more types are included, an arrangement order thereof may be random or block. X is F or CF₃.

The subscript p is an integer of 1 to 200, preferably 10 to 100; q is 0, 1 or 2, preferably 0 or 1; r is an integer of 1 to 5, preferably 1 or 2; h is an integer of 0 to 4, preferably 0 or 1; k is an integer of 2 to 16, preferably 2 to 6; and m is 2 or 3, preferably 3.

R¹ is hydrogen or a monovalent hydrocarbon group of 1 to 10 carbon atoms, preferably hydrogen or a monovalent hydrocarbon group of 1 to 8 carbon atoms, and most preferably hydrogen. Examples of R³ include hydrogen, saturated hydrocarbon groups such as methyl, ethyl, n-propyl, isopropyl, n-butyl, and isobutyl, and aromatic hydrocarbon groups such as phenyl, benzyl, and 1-phenylethyl.

R² and R³ are each independently a monovalent hydrocarbon group of 1 to 10 carbon atoms, preferably 1 to 8 carbon atoms. Examples include saturated hydrocarbon groups such as methyl, ethyl, n-propyl, isopropyl, n-butyl, and isobutyl, and aromatic hydrocarbon groups such as phenyl, benzyl, and 1-phenylethyl, with methyl being preferred.

Z is a hydrolyzable group. Examples of the hydrolyzable group include alkoxy groups such as methoxy, ethoxy, and propoxy, haloalkoxy groups such as trifluoromethoxy, trifluoroethoxy, and trichloroethoxy, alkoxy-substituted alkoxy groups such as methoxyethoxy, acyloxy groups such as acetoxy, propionyloxy, and benzoyloxy, alkenyloxy groups such as isopropenyloxy and isobutenyloxy, iminoxy groups such as dimethylketoxime, methylethylketoxime, diethylketoxime, and cyclohexaneoxime, substituted amino groups such as methylamino, ethylamino, dimethylamino, and diethylamino, amide groups such as N-methylacetamide and N-ethylamide, substituted aminooxy groups such as dimethylaminooxy and diethylaminooxy, and halogen groups such as chlorine. Of these examples of Z, methoxy, ethoxy, trifluoroethoxy, acetoxy, isopropenyloxy, chlorine, dimethylketoxime, and methylethylketoxime are preferred, with methoxy and ethoxy being more preferred. Z may be a single group or a combination of two or more groups in the fluorinated organosilane compound.

The fluorinated organosilane compound should preferably have a number average molecular weight (Mn) of 500 to 40,000, more preferably 500 to 30,000, and even more preferably 1,000 to 20,000, as measured versus polystyrene standards by GPC. If Mn is less than 500, water/oil repellent and antifouling properties inherent to the perfluoroalkylene ether structure may not be fully exerted. If Mn exceeds 40,000, too low a concentration of the terminal functional group may result in a decline of reactivity with and adhesion to a substrate.

As used herein, the number average molecular weight (Mn) refers to a number average molecular weight as measured versus polystyrene standards by gel permeation chromatography (GPC) under the following conditions.

Measurement conditions
Developing solvent: hydrochlorofluorocarbon (HCFC-225)
Flow rate: 1 mL/min
Detector: Evaporative light scattering detector
Column: TSKgel Multipore HXL-M (Tosoh Corp.) 7.8 mm ID×30 cm, 2 columns
Column Temperature: 35° C.
Sample amount injected: 100 μL (HCFC-225 solution with concentration 0.3 wt %)

The fluorinated organosilane compound preferably has a fluorine atom content of from 20% by weight to less than 70% by weight, more preferably from 40% by weight to less than 70% by weight, as measured by ¹⁹F-NMR. A fluorine content of less than 20% by weight may fail to provide the desired water/oil repellent and antifouling properties, whereas a fluorine content of 70% by weight or higher may fail to provide the desired adhesion and durable properties.

The fluorinated organosilane compound of formula (1) may be obtained, for example, by reacting an iodine-terminated fluorinated compound of the general formula (I) with a silane compound of the general formula (II) in the presence of a radical initiator in a well-known manner and reducing the iodine in the resulting compound with a reducing agent in a well-known manner.

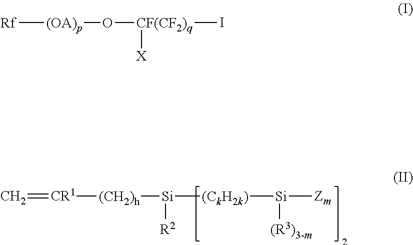

Herein Rf, OA, X, R¹ to R³, Z, p, q, h, k, and m are as defined above.

Notably, the fluorinated organosilane compound of formula (1) wherein r is 2 to 5 may be similarly obtained aside from changing reaction conditions, such as by increasing the amount of the radical initiator, extending the reaction time, elevating the reaction temperature, or increasing the charge of the silane compound of formula (II) whereby a plurality of silane compounds having formula (II) as the terminal modifier are added in a chain-reaction fashion.

Examples of the iodine-terminated fluorinated compound of formula (I) are listed below.

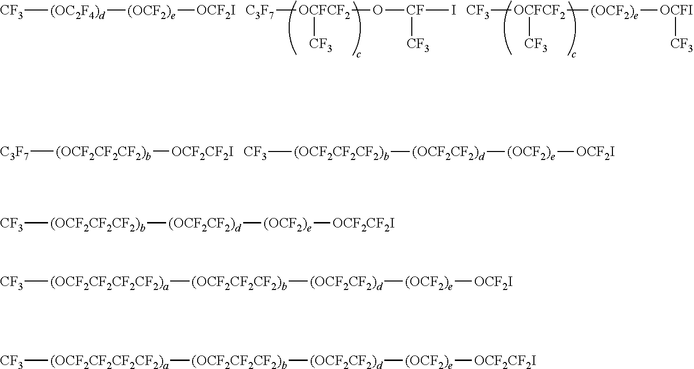

Herein, a, b, c, d, and e each are an integer of 0 to 200, a+b+c+d+e is 1 to 200.

Examples of the silane compound of formula (II) are listed below.

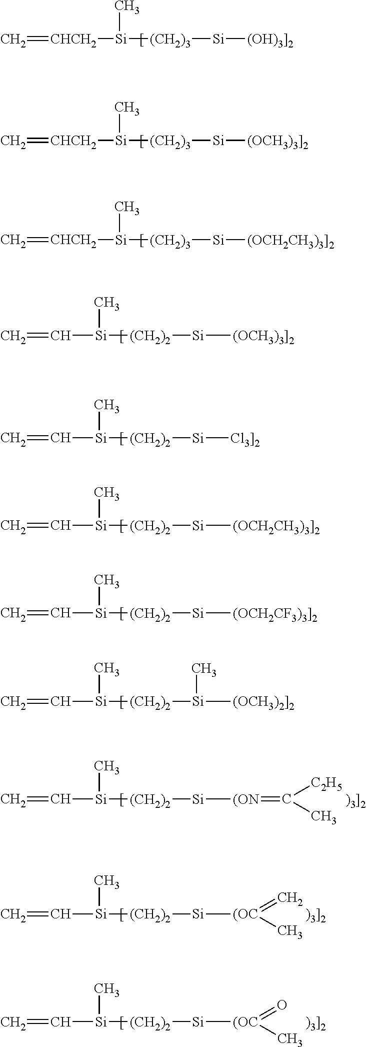

The silane compound of formula (II) may be synthesized by hydrosilylation reaction of a trialkenylsilane compound having the formula (i) with a SiH-containing silane compound having the formula (ii) in the presence of a transition metal catalyst.

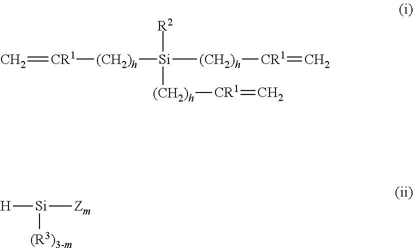

Herein R¹ to R³, Z, h and m are as defined above.

For the hydrosilylation reaction, the trialkenylsilane compound of formula (i) and the hydrosilyl-containing silane compound of formula (ii) are preferably used in such amounts that the molar ratio of SiH groups on the hydrosilyl-containing silane compound (ii) to alkenyl groups on the trialkenylsilane compound (i) may range from 0.4/1 to 0.8/1, more preferably from 0.5/1 to 0.8/1. If the molar ratio is less than 0.4, the desired compound may be obtained in low yields. If the molar ratio is more than 0.8, all alkenyl groups on the trialkenylsilane compound (i) may be reacted, failing to form the desired compound.

Suitable transition metal catalysts include ruthenium, rhodium, palladium, iridium, platinum and gold based catalysts, with the platinum based catalysts being preferred. Suitable platinum based catalysts include H₂PtCl₆.nH₂O, K₂PtCl₆, KHPtCl₆.nH₂O, K₂PtCl₄, K₂PtCl₄.nH₂O, and PtO₂.nH₂O wherein n is a positive integer. Also useful are complexes of the platinum based catalysts with hydrocarbons (typically, olefins), alcohols or vinyl-containing organopolysiloxanes. The catalysts may be used alone or in admixture.

The transition metal catalyst may be used in a catalytic or effective amount. Specifically, the catalyst is used in such amounts as to provide 0.1 to 100 ppm, more preferably 1 to 50 ppm of transition metal based on the total weight of trialkenylsilane compound (i) and hydrosilyl-containing silane compound (ii).

The hydrosilylation reaction may be conducted using only the silane compounds (i) and (ii) and the transition metal catalyst or after diluting the silane compounds with a solvent. The solvent used herein is not particularly limited as long as it does not interfere with the hydrosilylation reaction or react with the silane compounds. Suitable solvents include aromatic hydrocarbons such as toluene and xylene, and aliphatic hydrocarbons such as n-hexane, n-heptane and isooctane, with the aromatic hydrocarbons such as toluene and xylene being preferred. The amount of the solvent used is preferably 5 to 70% by weight, more preferably 10 to 50% by weight of the overall charge although the amount depends on the molecular weight and viscosity of the reactants (silane compounds) and the specific gravity of the solvent.

The solvent, if used, is preferably dehydrated or dried prior to the reaction because drying is effective for preventing alkoxy groups on the hydrosilyl-containing silane compound (ii) or the resulting silane compound (1) from hydrolysis so that the silane compound (1) is obtained in higher yields. No particular limits are imposed on the drying treatment of the solvent. Any water content after drying is acceptable as long as it corresponds to the level of commercially available dry solvents.

Preferably the hydrosilylation reaction is conducted at a temperature of 20 to 150° C., more preferably 50 to 100° C. for a time of 0.1 to 10 hours, more preferably 0.5 to 3 hours. As to pressure, atmospheric pressure is generally sufficient and preferable from the aspects of operation and economy. If necessary, the reaction may be conducted under applied pressure.

Back to the reaction to form the fluorinated organosilane compound of formula (1), the iodine-terminated fluorinated compound of formula (I) and the silane compound of formula (II) are preferably used in such amounts that the molar ratio of alkenyl on silane compound (II) to terminal iodine on fluorinated compound (I) may range from 0.5/1 to 20.0/1, more preferably from 1.0/1 to 10.0/1.

With respect to the reaction conditions, for example, the reaction may be conducted in a dry nitrogen atmosphere by heating at an internal temperature of 50 to 180° C. for about 30 minutes to about 4 hours, while a radical initiator may be added in an amount of 0.001 to 1 mole equivalent per iodine group on fluorinated compound (I). Suitable initiators include dibenzoyl peroxide, dicumyl peroxide, di-tert-butyl peroxide, tert-butyl peroxyacetate, tert-butyl peroxybenzoate, 2,5-dimethyl-2,5-di-tert-butyl peroxyhexane, tert-butylperoxy isopropyl monocarbonate, and azo initiators such as 2,2′-azobisisobutyronitrile.

Iodine in the resulting compound may be reduced using reducing agents, for example, hydrides such as sodium borohydride and aluminum lithium hydride and metals such as iron, zinc, nickel, aluminum, and magnesium. The amount of the reducing agent, expressed as reducing equivalent, is preferably at least 1 equivalent, more preferably at least 1.5 equivalents relative to the iodine. Although the temperature and time of reductive reaction may be selected optimum depending on the type of reducing agent and the reduction mode, the reaction is generally conducted at room temperature (23° C.) to 100° C. for 1 to 24 hours.

Examples of the fluorinated organosilane compound of formula (1) thus obtained are given below, but not limited thereto.

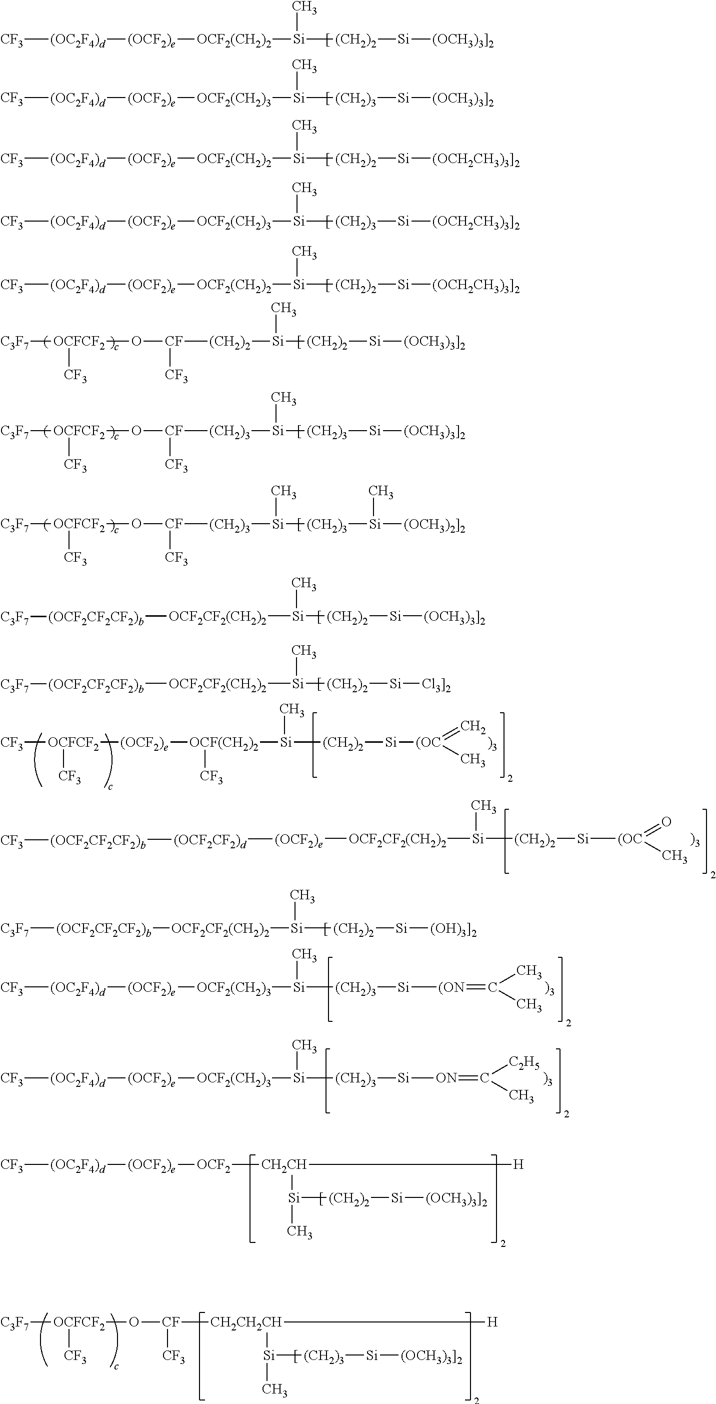

Herein b, c, d, and e are as defined above.

In addition to the fluorinated organosilane compound of formula (1), partial hydrolyzate or partial hydrolytic condensate thereof, the surface modifier of the invention may further comprise a solvent or diluent. Examples of the solvent or diluent include alcohols (e.g., ethyl alcohol and isopropyl alcohol), hydrocarbon solvents (e.g., petroleum benzine, mineral spirits, toluene and xylene), ester solvents (e.g., ethyl acetate, isopropyl acetate and butyl acetate), ether solvents (e.g., diethyl ether and isopropyl ether), and ketone solvents (e.g., acetone, methyl ethyl ketone and methyl isobutyl ketone). Of these, polar solvents including alcohols, esters, ethers and ketones are preferred. Inter alia, isopropyl alcohol and methyl isobutyl ketone are especially preferred for solubility, wettability, and safety. Also useful are fluorochemical solvents (perfluoro solvents). Suitable fluorochemical solvents include fluorinated aliphatic hydrocarbon solvents (e.g., perfluoroheptane), fluorinated aromatic hydrocarbon solvents (e.g., m-xylene hexafluoride and benzotrifluoride), and fluorinated ether solvents (e.g., methyl perfluorobutyl ether, ethyl perfluorobutyl ether, perfluoro(2-butyltetrahydrofuran), ethyl nonafluoroisobutyl ether, and ethyl nonafluorobutyl ether). Inter alia, fluorinated ether solvents are especially preferred for solubility and wettability. The solvents may be used alone or in admixture. In any case, those solvents in which the essential and optional components are uniformly dissolved are preferred.

The amount of solvent used is not particularly limited. Although the optimum concentration depends on a particular treating technique, the solvent is preferably used in such amounts that the modifier may have a solid content of 0.05 to 5.0% by weight, and more preferably 0.1 to 1.0% by weight. The solid content means the weight of nonvolatiles. When a curing catalyst and other additives are added to the modifier as will be described later, the solid content is the total weight of the compound of formula (1), partial hydrolyzate or hydrolytic condensate thereof, catalyst and additives.

If it is desired to have a fast cure rate, a curing catalyst may be optionally added to the surface modifier. Examples of the curing catalyst include organotitanic acid esters, organotitanium chelate compounds, organic aluminum compounds, organic zirconium compounds, organic tin compounds, metal salts of organocarboxylic acids, amine compounds and salts thereof, quaternary ammonium compounds, alkali metal salts of lower fatty acids, dialkylhydroxyamines, guanidyl-containing organosilicon compounds, inorganic acids, perfluorocarboxylic acids, and perfluoroalcohols. Of these, perfluorocarboxylic acids are preferably used.

Although the curing catalyst may be added in a catalytic amount, an appropriate amount is 0.05 to 5 parts, and more preferably 0.1 to 1 part by weight per 100 parts by weight of the fluorinated organosilane compound, partial hydrolyzate or hydrolytic condensate thereof.

The surface modifier thus formulated may be applied on a substrate by well-known techniques such as brush coating, dipping, spraying and evaporation.

Although the optimum treating temperature varies with a particular applying technique, a temperature from 10° C. to 200° C. is desirable in the case of brush coating or dipping, for example. The treatment is desirably carried out under humid conditions because humidity promotes the reaction. Although the treatment time varies with temperature and humidity conditions, the preferred time is at least 24 hours at room temperature (23° C.) and RH 50%, and at least 1 hour at 80° C. and RH 80%. It is understood that appropriate treating conditions are selected depending on the substrate, curing catalyst and the like.

The substrate to be treated with the surface modifier is not particularly limited. Various materials including paper, fabric, metals, metal oxides, glass, plastics, ceramics, and quartz may be used as the substrate. The surface modifier can impart water/oil repellency to the substrate. In particular, the modifier is advantageously used for the treatment of chemically strengthened glass, and glass and film which have been treated with SiO₂.

Although the thickness of the cured coating formed on the surface of substrates or articles may be selected depending on the type of substrate, the coating is preferably 1 to 100 nm, more preferably 3 to 20 nm thick.

The coating has not only water/oil repellency and quick water slip, but also better durability such as heat resistance, chemical resistance, and UV resistance than the prior art coatings. These properties are advantageous in applications which involve frequent water and UV exposure, troublesome maintenance, and adhesion of grease, fats, fingerprint, cosmetics, sunscreen cream, human or animal excrements, and oil. Examples of the application include anti-fingerprint coatings on glazing or strengthened glass in automobiles, trains, ships, aircraft, and tall buildings, head lamp covers, outdoor goods, telephone booths, large-size outdoor displays, sanitary ware such as bathtubs and washbowls, makeup tools, kitchen interior materials, aquarium tanks, and artistic objects. The coating is useful as anti-fingerprint coatings on compact discs and DVD's, mold parting agents, paint additives, and resin modifiers. Further applications include optical articles such as car navigation equipment, mobile phones, digital cameras, digital video cameras, PDA's, portable audio players, car audio devices, game consoles, eyeglass lenses, camera lenses, lens filters, sunglasses, medical devices such as gastric cameras, copiers, personal computers, liquid crystal displays, organic EL displays, plasma displays, touch panel displays, protective films, and antireflective films. The surface modifier of the invention is effective for preventing fingerprints and grease stains from adhering to the articles and also for imparting scratch resistance. Therefore, it is particularly useful as a water/oil repellent layer on touch panel displays and antireflective films.

### EXAMPLE

Examples of the invention are given below by way of illustration and not by way of limitation. In Examples, the number average molecular weight (Mn) was determined by GPC versus polystyrene standards, and the fluorine content was determined by ¹⁹F-NMR. Me stands for methyl.

### Synthesis Example 1

A 100-ml three-neck flask equipped with a Dimroth condenser, dropping funnel, thermometer, and magnetic stirrer was charged with 30 g of an iodine-terminated fluorinated compound of average compositional formula (1a) below (Mn=3,700, iodine concentration=0.026 mol/100 g), 1.12 g of di-tert-butyl peroxide, 11.5 g of a vinyl-containing silane compound of formula (2a) below (vinyl concentration=0.272 mol/100 g), which was obtained in Preparation Example 1 to be described below, and 30 g of 1,3-bis(trifluoromethyl)benzene, and purged with nitrogen. With stirring, reaction was run at an internal temperature of 100° C. for 3 hours, followed by cooling to room temperature. To the reaction mixture were added 1.02 g of zinc powder and 30 g of methyl alcohol. With vigorous stirring, reaction was run at an internal temperature of 60° C. for 12 hours. The reaction solution was filtered through a filter to remove solids and then stripped of the solvent, unreacted silane, and low-boiling fractions at 100° C./1 mmHg, yielding 28 g of a product having formula (3a) below. The extinction of terminal iodine group and vinyl group and the retention of methoxy groups were ascertained by FT-IR, ¹H-NMR, and ¹⁹F-NMR. The product of formula (3a) had a Mn of 4,000 and a fluorine content of 57 wt %.

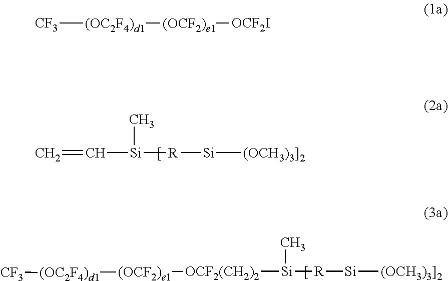

Herein e1/d1=˜0.9 and e1+d1=˜38. R is a mixture of —CH₂CH₂— and —CH(CH₃)—, and a ratio of —CH₂CH₂—/—CH(CH₃)— is approximately 0.65/0.35, as determined from the data of ¹H-NMR.

### Preparation Example 1

A 100-ml three-neck flask equipped with a Dimroth condenser, thermometer, and magnetic stirrer was charged with 12.4 g (0.10 mol) of methyltrivinylsilane, 12.4 g of dry toluene, and 0.20 g (5×10⁻⁶ mol) of a toluene solution of chloroplatinic acid modified with CH₂═CHSiMe₂OSiMe₂CH═CH₂ (platinum concentration 0.5 wt %), and heated in an oil bath until the internal temperature reached 70° C. Then 24.4 g (0.20 mol) of trimethoxysilane (to give a molar ratio of SiH groups on trimethoxysilane to vinyl groups on methyltrivinylsilane=2.0/3.0) was slowly added dropwise over about 1 hour, allowing addition reaction to take place via hydrosilylation. At the end of dropwise addition, the internal temperature was 85° C. After the completion of addition, the reaction solution was aged at an internal temperature of 70-80° C. for 1 hour, and cooled to room temperature. The reaction mixture was transferred to a distill pot where it was purified by distillation under reduced pressure while nitrogen bubbling. There was collected 25.4 g of a fraction at 145° C./3 mmHg to 155° C./3 mmHg.

On analysis by ¹H-NMR and IR spectroscopy, the liquid was identified to be a vinyl-containing silane compound having the following formula (2a).

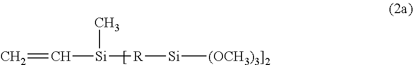

Herein R is a mixture of —CH₂CH₂— and —CH(CH₃)—, and a ratio of —CH₂CH₂—/—CH(CH₃)— is approximately 0.65/0.35, as determined from the data of ¹H-NMR.

### Synthesis Example 2

The procedure of Synthesis Example 1 was repeated according to the same formulation except that 15.4 g of a silane compound of the formula (4a) (allyl concentration=0.202 mol/100 g), which was obtained in Preparation Example 2 to be described below, was used instead of the silane compound of formula (2a), thereby yielding 28 g of a product of formula (5a). The product of formula (5a) had a Mn of 4,000 and a fluorine content of 56 wt %.

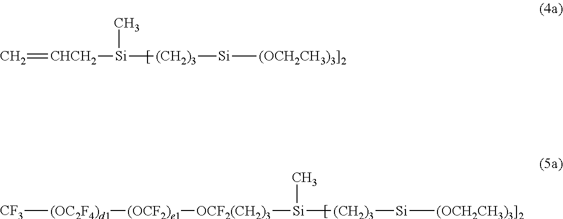

Herein e1/d1=˜0.9 and e1+d1=˜38.

### Preparation Example 2

A 100-ml three-neck flask equipped with a Dimroth condenser, thermometer, and magnetic stirrer was charged with 16.6 g (0.10 mol) of methyltriallylsilane, 22.7 g of dry toluene, and 0.20 g (5×10⁻⁶ mol) of a toluene solution of chloroplatinic acid modified with CH₂═CHSiMe₂OSiMe₂CH═CH₂ (platinum concentration 0.5 wt %), and heated in an oil bath until the internal temperature reached 70° C. Then 36.1 g (0.22 mol) of triethoxysilane (to give a molar ratio of SiH groups on triethoxysilane to allyl groups on methyltriallylsilane=2.2/3.0) was slowly added dropwise over about 1 hour, allowing addition reaction to take place via hydrosilylation. At the end of dropwise addition, the internal temperature was 85° C. After the completion of addition, the reaction solution was aged at an internal temperature of 70-80° C. for 1 hour, and cooled to room temperature. The reaction mixture was transferred to a distill pot where it was purified by distillation under reduced pressure while nitrogen bubbling. There was collected 27.1 g of a fraction at 157° C./1 mmHg to 168° C./1 mmHg.

On analysis by ¹H-NMR and IR spectroscopy, the liquid was identified to be a vinyl-containing silane compound having the following formula (4a).

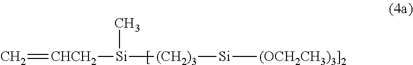

### Synthesis Example 3

The procedure of Synthesis Example 1 was repeated according to the same formulation except that 30 g of a fluorinated compound of the formula (6a) (Mn=4,100, iodine concentration=0.024 mol/100 g) was used instead of the fluorinated compound of formula (1a), thereby yielding 27 g of a product of formula (7a). The product of formula (7a) had a Mn of 4,400 and a fluorine content of 62 wt %.

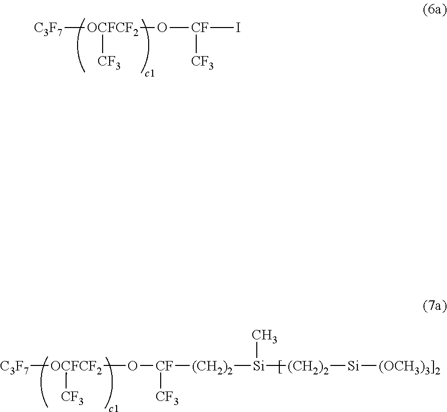

Herein c1=˜22.

### Comparative Synthesis Example 1

### Compound Containing Ether Bond in Linker

A 100-ml three-neck flask equipped with a Dimroth condenser, dropping funnel, thermometer, and magnetic stirrer was charged with 30 g of an allyl-terminated fluorinated compound of average compositional formula (8a) below (Mn=3,700, allyl concentration=0.026 mol/100 g) and 0.05 g of a toluene solution of 1,3-divinyl-1,1,3,3-tetramethyldisiloxane-modified chloroplatinic acid (platinum concentration 0.5 wt %) as catalyst. With stirring, the flask was heated at an internal temperature of 80° C. From the dropping funnel, 1.2 g of trimethoxysilane (SiH concentration=0.0082 mol/g) was added dropwise over about 5 minutes to the reaction mixture, which was aged for 2 hours at an internal temperature of 80-90° C. The reaction mixture was stripped of the unreacted silane at 100° C./5 mmHg, yielding 31 g of a product of formula (9a). The extinction of allyl group and SiH group was ascertained by FT-IR, ¹H-NMR, and ¹⁹F-NMR. The product of formula (9a) had a Mn of 3,800 and a fluorine content of 62 wt %.

CF₃—(OC₂F₄)_{d1}—(OCF₂)ₑ₁—OCF₂—CH₂OCH₂CH═CH₂ (8a)

CF₃—(OC₂F₄)_{d1}—(OCF₂)ₑ₁—OCF₂—CH₂OCH₂CH₂CH₂—Si—(OCH₃)₃ (9a)

Herein e1/d1=˜0.9 and e1+d1=˜38.

### Comparative Synthesis Example 2

### Compound Containing Siloxane Bond in Linker

A 100-ml three-neck flask equipped with a Dimroth condenser, dropping funnel, thermometer, and magnetic stirrer was charged with 30 g of an vinyl-terminated fluorinated compound of average compositional formula (10a) below (Mn=4,100, vinyl concentration=0.024 mol/100 g) and 0.05 g of a toluene solution of 1,3-divinyl-1,1,3,3-tetramethyldisiloxane-modified chloroplatinic acid (platinum concentration 0.5 wt %) as catalyst. With stirring, the flask was heated at an internal temperature of 120° C. From the dropping funnel, 3.0 g of a silane compound of formula (11a) (SiH concentration=0.0036 mol/g) was added dropwise over about 5 minutes to the reaction mixture, which was aged for 2 hours at an internal temperature of 110-120° C. The reaction mixture was stripped of the unreacted silane at 110° C./3 mmHg, yielding 32 g of a product of formula (12a). The extinction of vinyl group and SiH group was ascertained by FT-IR, ¹H-NMR, and ¹⁹F-NMR. The product of formula (12a) had a Mn of 4,400 and a fluorine content of 66 wt %.

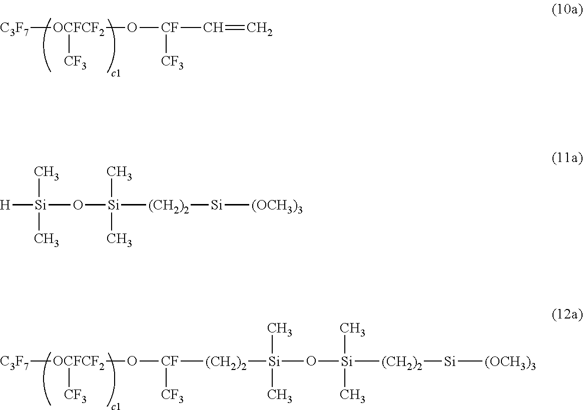

Herein c1=˜22.

### Comparative Synthesis Example 3

A 100-ml three-neck flask equipped with a Dimroth condenser, dropping funnel, thermometer, and magnetic stirrer was charged with 30 g of an iodine-terminated fluorinated compound of average compositional formula (1a) (Mn=3,700, iodine concentration=0.026 mol/100 g), 1.12 g of di-t-butyl peroxide, 7.3 g of a vinyl-containing silane compound of formula (13a) below (vinyl concentration=0.427 mol/100 g), and 30 g of 1,3-bis(trifluoromethyl)benzene, and purged with nitrogen. With stirring, reaction was run at an internal temperature of 100° C. for 3 hours, followed by cooling to room temperature. To the reaction mixture were added 1.02 g of zinc powder and 30 g of methyl alcohol. With vigorous stirring, reaction was run at an internal temperature of 60° C. for 12 hours. The reaction solution was filtered through a filter to remove solids and then stripped of the solvent, unreacted silane, and low-boiling fractions at 100° C./1 mmHg, yielding 28 g of a product having formula (14a) below. The extinction of terminal iodine group and vinyl group and the retention of methoxy groups were ascertained by FT-IR, ¹H-NMR, and ¹⁹F-NMR. The product of formula (14a) had a Mn of 3,900 and a fluorine content of 61 wt %.

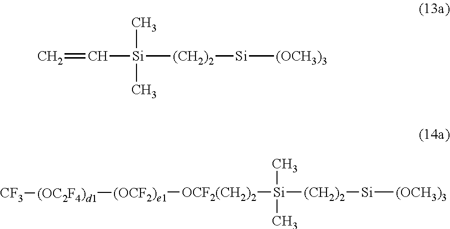

Herein e1/d1=˜0.9 and e1+d1=˜38.

### Examples 1 to 3 and Comparative Examples 1 to 3

### Preparation of Surface Modifier and Formation of Cured Coating

Each of the products (fluorinated polymer compounds) of Synthesis Examples 1 to 3 and Comparative Synthesis Examples 1 to 3 was dissolved in Novec 7200 (ethyl perfluorobutyl ether, 3M Company) at a concentration of 0.1 wt %, obtaining a treating bath. A chemically strengthened glass substrate of 50 mm×100 mm (Gorilla®, Corning Inc.) was immersed in the treating bath for 30 seconds, pulled up at a rate of 150 mm/minute, and allowed to stand in a thermo-hygrostat at 80° C./RH 80% for one hour. A cured coating of 5 to 7 nm thick was formed on the glass.

### Water/Oil Repellency Test

The samples were examined for water/oil repellency at the initial and after heating, UV exposure, and chemical immersion.

Initial Water/Oil Repellency Test

Using a contact angle meter Drop Master (Kyowa Interface Science Co., Ltd.), the cured coating on the glass was measured for a contact angle with water (water repellency) and a contact angle with oleic acid (oil repellency). The results are shown in Table 1.

TABLE 1
Initial water/oil repellency

| | | Water repellency | Oil repellency |
|---|---|---|---|
| | Surface modifier | (°) | (°) |
| Example 1 | Synthesis Example 1 | 116 | 75 |
| Example 2 | Synthesis Example 2 | 115 | 72 |
| Example 3 | Synthesis Example 3 | 114 | 73 |
| Comparative | Comparative | 116 | 74 |
| Example 1 | Synthesis Example 1 | | |
| Comparative | Comparative | 114 | 72 |
| Example 2 | Synthesis Example 2 | | |
| Comparative | Comparative | 116 | 75 |
| Example 3 | Synthesis Example 3 | | |

All samples exhibited good water/oil repellency at the initial.

Heat Resistance Test

The glass having the cured coating was held in an oven at 250° C. for 3 hours before it was rubbed with steel wool over 2,000 back-and-forth strokes. The coating surface was measured for a contact angle with water (water repellency). The results are shown in Table 2.

Steel Wool Abrasion Conditions
Steel wool: BONSTAR #0000 (Nippon Steel Wool Co., Ltd)
Moving distance (one stroke): 30 mm
Moving speed: 1,600 mm/min
Load: 1 kg/cm²

TABLE 2
Heat resistance

| | | Water |
|---|---|---|
| | | repellency |
| | Surface modifier | (°) |
| Example 1 | Synthesis Example 1 | 110 |
| Example 2 | Synthesis Example 2 | 108 |
| Example 3 | Synthesis Example 3 | 107 |
| Comparative Example 1 | Comparative Synthesis Example 1 | 85 |
| Comparative Example 2 | Comparative Synthesis Example 2 | 103 |
| Comparative Example 3 | Comparative Synthesis Example 3 | 110 |

The compound containing an ether bond in a linker (Comparative Example 1) marked a substantial reduction of contact angle, which indicates poor heat resistance.

UV Resistance Test

The glass having the cured coating was exposed to UV from a metal halide lamp in an illuminance of 540 W/m² (wavelength range of 300 to 400 nm) for 240 hours. The coating surface was measured for a contact angle with water (water repellency). The results are shown in Table 3.

TABLE 3
UV resistance

| | | Water |
|---|---|---|
| | | repellency |
| | Surface modifier | (°) |
| Example 1 | Synthesis Example 1 | 113 |
| Example 2 | Synthesis Example 2 | 112 |
| Example 3 | Synthesis Example 3 | 111 |
| Comparative Example 1 | Comparative Synthesis Example 1 | 93 |
| Comparative Example 2 | Comparative Synthesis Example 2 | 110 |
| Comparative Example 3 | Comparative Synthesis Example 3 | 113 |

The compound containing an ether bond in a linker (Comparative Example 1) marked a substantial reduction of contact angle, which indicates poor UV resistance.

Chemical Resistance Test 1

The glass having the cured coating was immersed in 4.5 wt % potassium hydroxide aqueous solution at 45° C. for 1 hour (Treatment 1). The coating surface was measured for a contact angle with water (water repellency). Similarly, the glass having the cured coating was immersed in 1.0 wt % hydrochloric acid water at 23° C. for 72 hours (Treatment 2). The coating surface was measured for a contact angle with water (water repellency). The results are shown in Table 4.

TABLE 4
Chemical resistance

| | | Water repellency (°) | |
|---|---|---|---|
| | | Treatment | Treatment |
| | Surface modifier | 1 | 2 |
| Example 1 | Synthesis Example 1 | 114 | 112 |
| Example 2 | Synthesis Example 2 | 113 | 112 |
| Example 3 | Synthesis Example 3 | 111 | 111 |
| Comparative | Comparative Synthesis Example 1 | 110 | 112 |
| Example 1 | | | |
| Comparative | Comparative Synthesis Example 2 | 88 | 92 |
| Example 2 | | | |
| Comparative | Comparative Synthesis Example 3 | 114 | 113 |
| Example 3 | | | |

The compound containing a siloxane bond in a linker (Comparative Example 2) marked a substantial reduction of contact angle, which indicates poor chemical resistance.

Chemical Resistance Test 2

The glass having the cured coating was immersed in 1.0 wt % sodium hydroxide aqueous solution at 30° C. for 72 hours. The coating surface was measured for a contact angle with water (water repellency). The results are shown in Table 5.

TABLE 5
Chemical resistance

| | | Water |
|---|---|---|
| | | repellency |
| | Surface modifier | (°) |
| Example 1 | Synthesis Example 1 | 112 |
| Example 2 | Synthesis Example 2 | 111 |
| Example 3 | Synthesis Example 3 | 111 |
| Comparative Example 1 | Comparative Synthesis Example 1 | 80 |
| Comparative Example 2 | Comparative Synthesis Example 2 | 79 |
| Comparative Example 3 | Comparative Synthesis Example 3 | 82 |

Comparative Examples 1 to 3 with fewer hydrolyzable silyl groups (only one Si linked to a hydrolyzable group) marked a substantial reduction of contact angle, which indicates poor chemical resistance.

As seen from these results, the surface modifiers comprising organosilicon-containing fluoropolymer compounds as defined herein have better heat resistance, UV resistance, and chemical resistance than the prior art modifiers, and especially, fully durable alkali resistance.

Japanese Patent Application No. 2014-001578 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A surface modifier comprising at least one compound selected from the group consisting of an organosilicon-containing fluoropolymer compound having the general formula (1), a partial hydrolyzate thereof, and a partial hydrolytic condensate thereof, 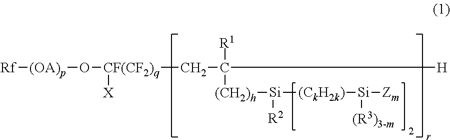
wherein Rf is a straight or branched perfluoroalkyl of 1 to 10 carbon atoms, OA is at least one group selected from the group consisting of OCF₂CF₂CF₂CF₂, OCF₂CF₂CF₂, OCF(CF₃)CF₂, OCF₂CF₂, and OCF₂, an arrangement order of OA may be random or block, X is F or CF₃, p is an integer of 1 to 200, q is 0, 1 or 2, r is an integer of 1 to 5, h is an integer of 0 to 4, k is an integer of 2 to 16, m is 2 or 3, R¹ is hydrogen or a monovalent hydrocarbon group of 1 to 10 carbon atoms, R² and R³ are each independently a monovalent hydrocarbon group of 1 to 10 carbon atoms, and Z is a hydrolyzable group.

2. The surface modifier of claim 1 wherein in formula (1), h is 0 or 1, k is 2 or 3, and m is 3.

3. The surface modifier of claim 2 wherein in formula (1), r is 1 or 2.

4. The surface modifier of claim 1 wherein the organosilicon-containing fluoropolymer compound of formula (1) has a number average molecular weight of 500 to 40,000.

5. An article treated with the surface modifier of claim 1.

6. An optical article treated with the surface modifier of claim 1.

7. A touch panel treated with the surface modifier of claim 1.

8. An antireflective film treated with the surface modifier of claim 1.

9. A SiO₂-treated glass treated with the surface modifier of claim 1.

10. A strengthened glass treated with the surface modifier of claim 1.

11. A quartz substrate treated with the surface modifier of claim 1.
